(19) United States
(12) Patent Application Publication
(10) Pub. No.: US 2014/0060324 A1
(43) Pub. Date: Mar. 6, 2014

(54) METHOD OF PREPARING GAS SELECTIVE MEMBRANE USING EPOXY-FUNCTIONAL SILOXANES

(71) Applicants: Dongchan Ahn, Midland, MI (US); Christopher Wong, Mountain View, CA (US); James S. Hrabal, St. Louis, MI (US)

(72) Inventors: Dongchan Ahn, Midland, MI (US); Christopher Wong, Mountain View, CA (US); James S. Hrabal, St. Louis, MI (US)

(73) Assignee: Dow Corning Corporation, Midland, MI (US)

(21) Appl. No.: 14/110,335

(22) PCT Filed: Apr. 4, 2012
(86) PCT No.: PCT/US12/32165

§ 371 Date: Nov. 13, 2013

Related U.S. Application Data
(60) Provisional application No. 61/473,193, filed on Apr. 8, 2011.

(51) Int. Cl. B01D 71/70; B01D 67/00; B01D 53/22

(52) U.S. Cl. CPC B01D 71/70; B01D 53/228; B01D 67/0006
USPC 95/51; 210/500.37; 210/500.23; 96/4; 96/10; 95/45; 427/386

(57) ABSTRACT

The present invention relates to a membrane including a reaction product of an epoxy-functional organopolysiloxane and an amino-functional curing agent, wherein the organopolysiloxane has an average of at least two silicon-bonded epoxy-substituted organic groups per molecule and the curing agent has an average of at least two nitrogen-bonded hydrogen atoms per molecule. The invention further relates to a method of separating gas components in a feed gas mixture by use of the membrane.

### CLAIM OF PRIORITY

This application claims the benefit of priority of U.S. application Ser. No. 61/473,193, filed Apr. 8, 2011, entitled “METHOD OF PREPARING GAS SELECTIVE MEMBRANE USING EPOXY-FUNCTIONAL SILOXANES,” which application is herein incorporated by reference in its entirety.

### BACKGROUND OF THE INVENTION

Artificial membranes can be used to perform separations on both a small and large scale, which makes them very useful in many settings. For example, membranes can be used to purify water, to cleanse blood during dialysis, and to separate gases. Some common driving forces used in membrane separations are pressure gradients and concentration gradients. Membranes can be made from polymeric structures, for example, and can have a variety of surface chemistries, structures, and production methods. Membranes can be made by hardening or curing a composition.

The use of membranes to separate gases is an important technique that can be used in many industrial procedures. Examples can include recovery of hydrogen gas in ammonia synthesis, recovery of hydrogen in petroleum refining, separation of methane from other components in biogas synthesis, enrichment of air with oxygen for medical or other purposes, removal of water vapor from natural gas, removal of carbon dioxide (CO₂) and dihydrogen sulfide (FLS) from natural gas, and carbon capture applications such as the removal of CO₂ from flue gas streams generated by combustion processes.

### SUMMARY OF THE INVENTION

The present invention relates to a membrane including a reaction product of an epoxy-functional organopolysiloxane and an amino-functional curing agent. The invention further relates to a method of separating gas components in a feed gas mixture. The membranes of the present invention can advantageously exhibit high permeability or selectivity for one or more particular components in a gas mixture. For example, the membrane of the present invention can exhibit high CO₂/N₂ selectivity compared with polydimethylsiloxane membranes cured by hydrosilylation, while retaining high permeability.

The present invention provides a membrane. The membrane includes a reaction product. The reaction product is the reaction product of an epoxy-functional organopolysiloxane and an amino-functional curing agent. The organopolysiloxane has an average of at least two silicon-bonded epoxy-substituted organic groups per molecule. The curing agent has an average of at least two nitrogen-bonded hydrogen atoms per molecule.

The present invention provides a method of separating gas components in a feed gas mixture. The method includes contacting a first side of a membrane with a feed gas mixture. The feed gas mixture includes a first gas component and a second gas component. The contacting produces a permeate gas mixture on a second side of the membrane. The contacting also produces a retentate gas mixture of the first side of the membrane. The permeate gas mixture is enriched in the first gas component. The retentate gas mixture is depleted in the first gas component. The membrane includes a reaction product. The reaction product is the reaction product of an epoxy-functional organopolysiloxane and an amino-curing agent. The organopolysiloxane has an average of at least two silicon-bonded epoxy-substituted organic groups per molecule. The ammo-functional curing agent has an average of at least two nitrogen-bonded hydrogen atoms per molecule.

In another embodiment, the present invention provides a membrane. The membrane includes a reaction product. The reaction product is the reaction product of an epoxy-functional organopolysiloxane and an amino-functional curing agent. The organopolysiloxane has an average of at least two silicon-bonded epoxy-substituted organic groups per molecule. The curing agent has an average of at least two nitrogen-bonded hydrogen atoms per molecule. The epoxy-functional organopolysiloxane can be represented by the average siloxane unit formula:

(R¹R²R³SiO_{1/2})ₐ(R⁴R⁵SiO_{2/2})_{b}(R⁶SiO_{3/2})_{c}(SiO_{4/2})_{d} (I)

wherein R¹, R², RJ, R⁴, R⁵, and R⁶ are organic groups independently selected from any optionally further substituted C₁₋₁₅ organic group, 0≦a<0.95, 0≦b<1, 0≦c<1, 0≦d<0.95, a+b+c+d=1, and the epoxy-functional organopolysiloxane has a number-average molecular weight of at least about 300. The ammo-functional curing agent includes a polyoxyalkyleneamine. The reaction product is formed by heating the epoxy-functional organopolysiloxane and the amino-functional curing agent. The membrane has a CO₂/N₂ selectivity of at least about 10. The membrane has a CO₂ permeability coefficient of at least about 900 Barrers. The membrane has a thickness of from about 0.1 μm to about 200 μm.

The present invention provides a method of forming a membrane. The method includes forming a coating. The coating includes an epoxy-functional organopolysiloxane. The coating also includes an ammo-functional curing agent. The method includes curing the coating. Curing the coating provides a membrane including a reaction product of the epoxy-functional organopolysiloxane and the ammo-functional curing agent. The organopolysiloxane has an average of at least two silicon-bonded epoxy-substituted organic groups per molecule. The curing agent has an average of at least two nitrogen-bonded hydrogen atoms per molecule.

In another embodiment, the present invention provides a method of forming a membrane. The method includes providing a porous or highly permeable nonporous substrate. The method includes forming a coating on at least part of the substrate. The coating includes an epoxy-functional organopolysiloxane. The coating also includes an ammo-functional curing agent. The method also includes curing the coating. Curing the coating provides a membrane on at least part of the substrate. The membrane includes a reaction product of the epoxy-functional organopolysiloxane and the ammo-functional curing agent. The organopolysiloxane has an average of at least two silicon-bonded epoxy-substituted organic groups per molecule. The curing agent has an average of at least two nitrogen-bonded hydrogen atoms per molecule. The epoxy-functional organopolysiloxane can be represented by the average siloxane unit formula:

(R¹R²R³SiO_{1/2})ₐ(R⁴R⁵SiO_{2/2})_{b}(R⁶SiO_{3/2})_{c}(SiO_{4/2})_{d} (I)

wherein R¹, R², R³, R⁴, R⁵, and R⁶ are organic groups independently selected from any optionally further substituted C₁₋₁₅ organic group, 0≦a<0.95, 0≦b<1, 0≦c<1, 0≦d<0.95, a+b+c+d=1, and the epoxy-functional organopolysiloxane has a number-average molecular weight of at least about 300. The ammo-functional curing agent includes a polyoxyalkyleneamine. The reaction product is formed by heating the epoxy-functional organopolysiloxane and the amino-functional curing agent. The membrane has a CO₂/N₂ selectivity of at least about 10. The membrane has a CO₂ permeability coefficient of at least about 900 Barrers. The membrane has a thickness of from about 0.1 μm to about 200 μm.

### DETAILED DESCRIPTION OF THE INVENTION

References in the specification to “one embodiment,” “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a concentration range of “about 0.1% to about 5%” should be interpreted to include not only the explicitly recited concentration of about 0,1 wt % to about 5 wt %, but also the individual concentrations (e.g., 1%, 2%, 3%, and 4%) and the sub-ranges (e.g., 0.5%, 1.1%, 2.2%, 3.3%, and 4.4%) within the indicated range.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. When a molecule is described having a substituent such as R, and multiple R-groups are included in the molecule, each R-group can independently be different or the same, unless otherwise specified. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

The following documents are hereby incorporated by reference: WO 2007/145711, and U.S. Patent Publication No. 2006/0058451.

Definitions

The term “about” can allow for a degree of variability in a value or range, for example, within 10%, within 5%, or within 1% of a stated value or of a stated limit of a range.

The terms “M”, “D”, “T”, and “Q” as used herein designate:

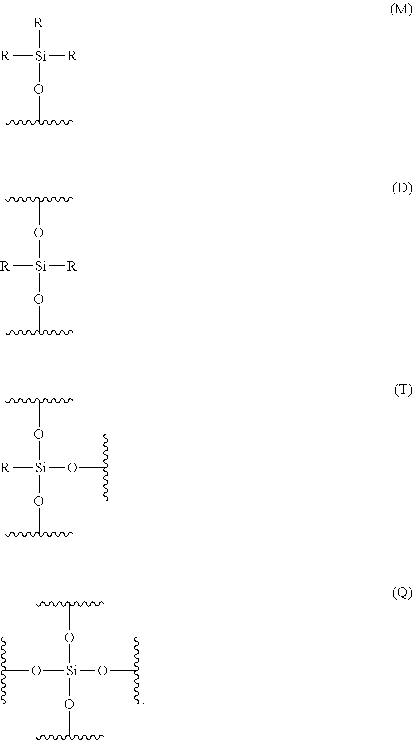

The terms “epoxy-functional” or “epoxy-substituted” as used herein refers to an organic group in which an oxygen atom, the epoxy substituent, is directly attached to two adjacent carbon atoms of a carbon chain or ring system. Examples of epoxy-substituted organic groups include, but are not limited to: 2,3-epoxypropyl, 3,4-epoxybutyl, 4,5-epoxypentyl, 2-glycidoxyethyl, 3-glycidoxypropyl, 2-(glycidoxycarbonyl)propyl, 4-glycidoxybutyl, 2-(3,4-epoxycylohexyl)ethyl, 3-(3,4-epoxycylokexyl)propyl, 2-(3,4-epoxy-3-methylcylohexyl)-2-methylethyl, 2-(2,3-epoxycylopentyl)ethyl, and 3-(2,3-epoxycylopentyl)propyl.

The term “organic group” as used herein refers to but is not limited to any carbon-containing functional group. Examples include acyl, cycloalkyl, aryl, aralkyl, heterocyclyl, heteroaryl, or heteroarylalkyl, linear and/or branched groups such as alkyl groups, fully or partially halogen-substituted haloalkyl groups, alkenyl groups, alkynyl groups, acrylate and methacrylate functional groups: and other organic functional groups such as ether groups, cyanate ester groups, ester groups, carboxylate salt groups, and masked isocyano groups.

The term “substituted” as used herein refers to an organic group as defined herein or molecule in which one or more hydrogen atoms contained therein are replaced by one or more non-hydrogen atoms. The term “functional group” or “substituent” as used herein refers to a group that can be or is substituted onto a molecule, or onto an organic group. Examples of substituents or functional groups include, but are not limited to, any organic group, a halogen (e.g., F, Cl, Br, and I); a sulfur atom in groups such as thiol groups, alkyl and aryl sulfide groups, sulfoxide groups, sulfone groups, sulfonyl groups, and sulfonamide groups; a nitrogen atom in groups such as amines, hydroxylamines, nitrites, nitro groups, N-oxides, hydrazides, azides, and enamines; and other heteroatoms in various other groups.

The term “alkyl” as used herein refers to straight chain and branched alkyl groups and cycloalkyl groups having from 1 to about 20 carbon atoms, and typically from 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, isobutyl, sec-butyl, t-butyl, neopentyl, isopentyl, and 2,2-dimethylpropyl groups. As used herein, the term “alkyl” encompasses all branched chain forms of alkyl. Representative substituted alkyl groups can be substituted one or more times with any functional group, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to about 20 carbon atoms, and typically from 2 to 12 carbons or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyelohexadienyl, butadienyl, pentadienyl, and hexadienyl, among others.

The term “aryl” as used herein refers to cyclic aromatic hydrocarbons.

The term “resin” as used herein refers to polysiloxane material of any viscosity that includes at least one siloxane monomer that is bonded via a Si—O—Si bond to three or four other siloxane monomers. In one example, the polysiloxane material includes T or Q groups, as defined herein.

The term “number-average molecular weight” as used herein refers to the ordinary arithmetic mean or average of the molecular weight of individual molecules. It is determined by measuring the molecular weight of n polymer molecules, summing the weights, and dividing by n.

The term “oligomer” as used herein refers to a molecule having an intermediate relative molecular mass, the structure of which essentially includes a small plurality of units derived, actually or conceptually, from molecules of lower relative molecular mass. A molecule having an intermediate relative mass can be a molecule that has properties that vary with the removal of one or a few of the units. The variation in the properties that results from the removal of the one of more units can be a significant variation.

The term “radiation” as used herein refers to energetic particles travelling through a medium or space. Examples of radiation are visible light, infrared light, microwaves, radio waves, very low frequency waves, extremely low frequency waves, thermal radiation (heat), and black-body radiation.

The term “cure” as used herein refers to exposing to radiation in any form, heating, or allowing to undergo a chemical reaction that results in hardening or an increase in viscosity.

The term “pore” as used herein refers to a depression, slit, or hole of any size or shape in a solid object. A pore can run all the way through an object or partially through the object. A pore can intersect other pores.

The term “coating” refers to a continuous or discontinuous layer of material on the coated surface, wherein the layer of material can penetrate the surface and can fill areas such as pores, wherein the layer of material can have any three-dimensional shape, including a flat or curved plane. In one example, a coating can be formed on one or more surfaces, any of which may be porous or nonporous, by immersion in a bath of coating material.

The term “surface” refers to a boundary or side of an object, wherein the boundary or side can have any perimeter shape and can have any three-dimensional shape, including flat, curved, or angular, wherein the boundary or side can be continuous or discontinuous.

The term “solvent” as used herein refers to a liquid that can dissolve a solid, liquid, or gas. Nonlimiting examples of solvents are silicones, organic compounds, water, alcohols, ionic liquids, and supercritical fluids.

The term “free-standing” or “unsupported” as used herein refers to a membrane with the majority of the surface area on each of the two major sides of the membrane not contacting a substrate, whether the substrate is porous or not. In some embodiments, a membrane that is “free-standing” or “unsupported” can be 100% not supported on both major sides. A membrane that is “free-standing” or “unsupported” can be supported at the edges or at the minority (e.g. less than about 50%) of the surface area on either or both major sides of the membrane.

The term “supported” as used herein refers to a membrane with the majority of the surface area on at least one of the two major sides contacting a substrate, whether the substrate is porous or not. In some embodiments, a membrane that is “supported” can be 100% supported on at least one side. A membrane that is “supported” can be supported at any suitable location at the majority (e.g. more than about 50%) of the surface area on either or both major sides of the membrane.

The term “selectivity” or “ideal selectivity” as used herein refers to the ratio of permeability of the faster permeating gas over the slower permeating gas, measured at room temperature.

The term “permeability” as used herein refers to the permeability coefficient (P_{X}) of substance X through a membrane, where q_{mX}=P_{X}*A*Δp_{X} *(1/delta), where qmx is the volumetric flow rate of substance X through the membrane, A is the surface area of one major side of the membrane through which substance X flows, Δp_{X} is the pressure difference of the partial pressure of substance X across the membrane, and delta is the thickness of the membrane. Unless otherwise specified, the permeability coefficients cited refer to those measured at ambient laboratory temperatures, e.g. 22±2° C.

The term “Barrer” or “Barrers” as used herein refers to a unit of permeability, wherein 1 Barrer=10⁻¹¹ (cm³ gas) cm cm⁻² s⁻¹ mmHg⁻¹, or 10⁻¹⁰ (cm³ gas) cm cm⁻² s⁻¹ cm Hg⁻¹, where “cm³ gas” represents the quantity of the gas that would take up one cubic centimeter at standard temperature and pressure.

The term “enrich” as used herein refers to increasing in quantity or concentration, such as of a liquid, gas, or solute. For example, a mixture of gases A and B can be enriched in gas A if the concentration or quantity of gas A is increased, for example by selective permeation of gas A through a membrane to add gas A to the mixture, or for example by selective permeation of gas B through a membrane to take gas B away from the mixture.

The term “deplete” as used herein refers to decreasing in quantity or concentration, such as of a liquid, gas, or solute. For example, a mixture of gases A and B can be depleted in gas A if the concentration or quantity of gas A is decreased, for example by selective permeation of gas B through a membrane to take gas B away from the mixture, or for example by selective permeation of gas A through a membrane to add gas A to the mixture.

The term “room temperature” as used herein refers to ambient temperature, which can be, for example, between about 15° C. and about 28° C..

The term “mil” as used herein refers to a thousandth of an inch, such that 1 mil=0.001 inch.

Description

The present invention relates to a membrane including a reaction product of an epoxy-functional organopolysiloxane and an amino-functional curing agent, wherein the organopolysiloxane has an average of at least two silicon-bonded epoxy-substituted organic groups per molecule and the curing agent has an average of at least two nitrogen-bonded hydrogen atoms per molecule. The invention further relates to a method of separating gas components in a feed gas mixture by use of the membrane.

Embodiments relate to gas selective membranes and methods of making the same that can allow highly selective separation of gas mixtures such as CO₂ from N₂ or methane, yet can retain higher permeability than conventional CO₂ selective polymer systems. The present invention overcomes limitations associated with common siloxane cure systems such as hydrosilylation and condensation, and also provides functionality useful for selective transport of certain gases such as CO₂. The method can include combining an epoxy-functional organopolysiloxane molecule with an ammo-functional compound, applying the composition on a surface or porous support to create a laminated film or composite, and curing the composition with heat to create a selective membrane that can be used for separation of gas mixtures. The surfaces or porous supports can be planar or curved, as embodied by a fiber. The invention also provides a method of separating gases by exposing a mixed gas stream to the resulting film or composite. For example, films prepared by this method can have CO₂/N₂ selectivities of about 10 or significantly greater and CO₂permeability coefficients of about 900 Barrers or significantly greater, which offer favorable combinations of CO₂/N₂ selectivity and CO₂ permeability relative to organic polymers or polydimethylsiloxane networks cured by hydrosilylation (CO₂/N₂ selectivities of about 10, CO₂ permeability coefficients between about 1000 and 2700 Barrers). The method provides a convenient, cost-effective manner to prepare and utilize membranes.

The composition that forms the membrane of the present invention includes an epoxy-functional organopolysiloxane that has an average of at least two silicon-bonded epoxy-substituted organic groups per molecule. The organopolysiloxane that has an average of at least two silicon-bonded epoxy-substituted organic groups per molecule can be present in from about 0.5 wt % to about 99.5 wt %, about 2.5 wt % to about 97.5 wt %, or about 5 wt % to about 95 wt % of the uncured composition. In some embodiments, the organopolysiloxane that has an average of at least two silicon-bonded epoxy-substituted organic groups per molecule can be present in from about 65 wt % to about 98 wt %, about 75 wt % to about 95 wt %, or about 85 wt % to about 90 wt % of the uncured composition. In some embodiments, the organopolysiloxane that has an average of at least two silicon-bonded epoxy-substituted organic groups per molecule can be present in from about 10 wt % to about 60 wt %, about 23 wt % to about 48 wt %, or about 33 wt % to about 38 wt % of the uncured composition. Wt % in this paragraph refers to the percent by weight based on the combined weight of the epoxy-functional organopolysiloxane and the amino-functional curing agent.

The composition that forms the membrane of the present invention includes an amino-functional curing agent that has an average of at least two nitrogen-bonded hydrogen atoms per molecule. The amino-functional curing agent that has an average of at least two nitrogen-bonded hydrogen atoms per molecule can be present in from about 0.5 wt % to about 99.5 wt %, about 2.5 wt % to about 97.5 wt %, or about 5 wt % to about 95 wt % of the uncured composition. In some embodiments, the amino-functional curing agent that has an average of at least two nitrogen-bonded hydrogen atoms per molecule can be present in from about 2 wt % to about 35 wt %, about 5 wt % to about 25 wt %, or about 10 wt % to about 15 wt % of the uncured composition. In some embodiments, the amino-functional curing agent that has an average of at least two nitrogen-bonded hydrogen atoms per molecule can be present in from about 40 wt % to about 90 wt %, about 52 wt % to about 77 wt %, or about 62 wt % to about 67 wt % of the uncured composition. Wt % in this paragraph refers to the percent by weight based on the combined weight of the epoxy-functional organopolysiloxane and the amino-functional curing agent.

Epoxy-Functional Organopolysiloxane

The present invention includes a reaction product of an epoxy-functional organopolysiloxane. The epoxy-functional organopolysiloxane can be the main ingredient of the composition that forms the membrane provided by the present invention. The present invention can include the reaction product of one type of epoxy-functional organopolysiloxane, or several types of epoxy-functional organopolysiloxanes. The epoxy-substituted organopolysiloxane can be any organopolysiloxane composition including at least one epoxy-substituted organic group. The organopolysiloxane compound can be a homopolymer or a copolymer. The organopolysiloxane compound can be a disiloxane, trisiloxane, or polysiloxane. The epoxy-functional organopolysiloxane can be linear, cyclic, branched, hyperhranched, dendrimeric or resinous. The epoxy-functional organopolysiloxane can have any average molecular weight ranging from oligomeric to very high molecular weight, and can have any molecular weight distribution ranging from monodisperse to highly polydisperse, and may exhibit a unimodal or multi-modal molecular weight distribution when tested by gel permeation chromatography. The epoxy-functional organopolysiloxane can have a number-average molecular weight of less than about 150 g/mol, less than about 300 g/mol, at least about 300, about 300 to about 1,000,000, about 1,000 to about 100,000, about 1,000 to 50,000, about 1,000 to 20,000, or about 1,000 to 10,000 g/mol. The epoxy-functional organopolysiloxane can be a resin. PCT application WO 2007/145711 (PCT/US2007/009917) includes a description of an organopolysiloxane resin and epoxy-substituted organic groups suitable as examples of an organopolysiloxane resin and epoxy-substituted organic groups in certain embodiments of the present invention.

The epoxy-functional organopolysiloxane contains at least one epoxy-substituted organic group, capable of reacting in the presence of an amino-functional curing agent to form a cured product of the epoxy-functional organopolysiloxane. The epoxy-functional organopolysiloxane can optionally contain other silicon-bonded reactive groups capable of reacting in the presence or absence of a curing agent or initiator to form a cured product of the epoxy-functional organopolysiloxane. Examples of silicon-bonded reactive groups include, but are not limited to, —H, alkenyl, alkynyl, alkoxy, —OH, a hydrolysable group, alkenyl ether, acryloyloxyalkyl, and a substituted acryloyloxyalkyl group. In some embodiments, the epoxy-functional organopolysiloxane can have an average of at least two silicon-bonded epoxy-substituted organic groups per molecule.

The present invention encompasses a wide range of epoxy-functional organopolysiloxanes to form the membrane. Although specific examples are given herein, one of skill in the art will appreciate that any epoxy-functional organopolysiloxane that can form a suitable reaction product with art amino-functional curing agent is encompassed by the present invention. In some examples, the reaction product of the epoxy-substituted organopolysiloxane includes little or no unreacted epoxy-substituted organopolysiloxane. In other examples, the reaction product of tire epoxy-substituted organopolysiloxane can include unreacted epoxy-substituted organopolysiloxane.

In some embodiments, the epoxy-functional organopolysiloxane can include organopolysiloxane compounds having formulae selected from:

R¹₃SiO(R¹₂SiO)ₐ(R¹R²SiO)_{b}SiR¹₃;

wherein a has a value of zero to 20,000 and b has a value of 1 to 20,000; and wherein each R¹ group is independently a hydrogen, halogen, or a monovalent organic group, and each R² group is independently an epoxy-containing group; and,

R³₂R⁴SiO(R³₂SiO)_{c}(R³R⁴SiO)_{d}SiR³₂R⁴;

wherein c has a value of zero to 20,000, and d has a value of zero to 20,000; and wherein each R³ is independently a hydrogen, halogen, or a monovalent organic group, and each R⁴ group is independently an epoxy-containing group. Suitable R¹ and R³ groups include, but are not limited to, acrylic groups; alkyl; halogenated hydrocarbon groups; alkenyl; alkynyl; aryl; cyanoalkyl; and any suitable C₁₋₁₅ organic group. Suitable R² and R⁴ groups include but are not limited to examples of epoxy-functional groups given herein.

Suitable epoxy-substituted organopolysiloxane can be epoxy-functional organopolysiloxanes having ‘dumbbell’ like features including cyclosiloxanes linked together by linear organopolysiloxane segments, wherein the rings have at least partial substitution of epoxy-functional groups. Examples of such structures, and methods of making such compounds can be found in U.S. Pat. Nos. 7,429,636 B2 and 7,378,482 B2.

The epoxy-functional organopolysiloxane can include T siloxane units, T and Q siloxane units, or T and/or Q siloxane units in combination with M and/or D siloxane units. For example, the epoxy-functional organopolysiloxane can be a T resin, a TQ resin, an MT resin, a DT resin, an MDT resin, an MQ resin, a DO resin, an MDQ resin, an MTQ resin, a DTQ resin, or an MDTQ resin.

An epoxy-functional organopolysiloxane resin can be represented by the average siloxane unit formula:

(R¹R²R³SiO_{1/2})ₐ(R⁴R⁵SiO_{2/2})_{b}(R⁶SiO_{3/2})_{c}(SiO_{4/2})_{d} (I)

wherein R¹, R², R′, R⁴, R⁵, and R⁶ are organic groups independently selected from any optionally further substituted C₁₋₁₅ organic group, including C₁₋₁₅ monovalent aliphatic hydrocarbon groups, C₄₋₁₅ monovalent aromatic hydrocarbon groups, and monovalent epoxy-substituted organic groups, 0≦a<0.95, 0≦b<1, 0≦c<1, 0≦d<0.95, a+b+c+d+1, c+d>0, the resin has a number-average molecular weight of at least about 1000, and there is an average of at least two silicon-bonded epoxy-substituted organic groups per molecule. In some embodiments, the optionally further substituted C₁₋₁₅ organic group includes monovalent aliphatic hydrocarbon groups and monovalent epoxy-substituted organic groups. Due to the epoxy groups it contains, the resin can quickly cure upon reaction with ammo-functional curing agents, or optionally in the presence of a cationic photoinitiator upon irradiation with active energy rays, such as UV rays, electron beams, or ionizing radiation. The cured composition can be removably or non-removably adhered to a substrate.

Referring to formula (1) above, one of skill in the art will readily appreciate that when the condition c+d>0 is removed, a condition b>0 is added, and the minimum number average-molecular weight is lowered to about 300, the organopolysiloxane may be referred to as a linear organopolysiloxane. Embodiments of the present invention encompass formula (I) with either, both, or neither of the conditions c+d>0 and b>0 imposed.

In some embodiments, in the epoxy-functional organopolysiloxane resin represented by the average siloxane unit formula (I), there can be epoxy-functional organopolysiloxane resins including the following units:

(R⁴R⁵SiO_{2/2})_{b}(R⁶SiO_{3/2})_{c};

(R¹R²R³SiO_{1/2})ₐ(R⁴R⁵SiO_{2/2})_{b}(R⁶SiO_{3/2})_{c};

(R⁴R⁵SiO_{2/2})_{b}(R⁶SiO_{3/2})_{c}(SiO_{4/2})_{d}; or

(R¹R²R³SiO_{1/2})ₐ(R⁴R⁵SiO_{2/2})_{b}(R⁶SiO_{3/2})_{c}(SiO_{4/2})_{d}; or

(R⁴R⁵SiO_{2/2})_{b}; or

(R⁶SiO_{3/2})_{c}.

In descriptions of average unit formula, such as formula I, the subscripts a, b, c, and d are mole fractions. The subscript a typically has a value of from about 0 to about 0.95, alternatively from about 0 to about 0.8, alternatively from about 0 to about 0.2. The subscript b typically has a value of from about 0 to about 1, alternatively from about 0 to about 0.95, alternatively from about 0 to about 0.8. alternatively from about 0 to about 0.5, The subscript c typically has a value of from about 0 to about 1, alternatively from about 0.3 to about 1, alternatively from about 0.5 to about 1. The subscript d typically has a value of from about 0 to about 0.95, alternatively from about 0 to about 0.5, alternatively from about 0 to about 0.1.

In some embodiments, the subscript values for formula (I) can be: a is from 0 to 0.95, b is from 0 to 0.95, c is from 0 to 1, d is from 0 to 0.9, c+d is from 0.1 to 1, and a+b+c+d=1. In some embodiments, subscripts c and d satisfy the condition: 0.1≦c+d≧1. In some embodiments, the subscript values for formula (I) can be: 0≦a<0.4, 0<b<0.5, 0<c<1, 0≦d<0.4, where a+b+c+d=1. In some embodiments, subscripts b and c satisfy the condition 0.1≦b/c≦0.3. The subscript a can be 0≦a<0.4 because the molecular weight of the epoxy-containing organopolysiloxane resin can drop when there are too many (R¹R²R³SiO_{1/2}) units, and, when (SiO_{4/2}) units are introduced, the hardness of the cured product of the epoxy-functional organopolysiloxane resin can be markedly increased and the product can be easily rendered brittle. For this reason, in some embodiments, the subscript d can be 0≦d<0.4, or 0≦d<0.2, and even d=0. In addition, the molar ratio b/c of the (R⁴R⁵SiO_{2/2}) units and (R⁶SiO_{3/2}) units can be, in some examples, not less than 0.01 and not more than 0.3. In some embodiments, deviation from this range can result in, for example, generation of insoluble side products, in making the product more prone to cracking due to decreased toughness, or in a decrease in the strength and elasticity of the product and making it more prone to scratching. A sub-range for the molar ratio b/c can be not less than 0.01 and not more than 0.25, and another sub-range can be not less than 0.02 and not more than 0.25, In some embodiments, the epoxy-functional organopolysiloxane resin can contain the (R⁴R⁵SiO_{2/2}) units and (R⁶SiO_{3/2}) units, and its molecular structure is in most cases a network structure or a three-dimensional one because the molar ratio of b/c is not less than 0.01 and not more than 0.3.

It is appreciated that those of skill in the art understand that for the average unit formula (I), the variables R¹, R², R³, R⁴, R⁵ and R⁶ can independently vary between individual siloxane units. Alternatively, the variables R¹, R², R³, R⁴, R⁵, and R⁶ can independently be the same between individual siloxane units. For example, average unit formula (I)

(R¹R²R³SiO_{1/2})ₐ(R⁴R⁵SiO_{2/2})_{b}(R⁶SiO_{3/2})_{c}(SiO_{4/2})_{d} (I)

can include the following average unit formula:

((R¹R²R³SiO_{1/2})ₐ(R⁴R⁵SiO_{2/2})_{b}(R^{6a}SiO_{3/2})_{c1}(R^{6b}SiO_{3/2})_{c2}(SiO_{4/2})_{d}

where subscripts c1+c2=c, and where R^{6a} is not equal to R^{6b}.

Similarly, for example, average unit formula (I) can include the following average unit formula:

(R¹R²R³SiO_{1/2})ₐ(R^{4a}R^{5a}SiO_{2/2})_{b1}(R^{4b}R^{5b}SiO_{2/2})_{b2}(R⁶SiO_{3/2})_{c}(SiO_{4/2})_{d}

where subscripts b1+b2=b, and where R^{4a} is not equal to R^{4b}, and where R^{5a} is not equal to R^{5b}.

The C₁₋₅ organic group of the epoxy-functional organopolysiloxane can be any silicon-bonded C₁₋₁₅ organic group known to one of skill in the art, and can be optionally further substituted with any suitable group known to one of skill in the art. The C₁₋₁₅ organic group can include any C₁₋₁₅ monovalent aliphatic hydrocarbon group, any C₄₋₁₅ monovalent aromatic hydrocarbon group, and any monovalent epoxy-substituted organic group.

The epoxy-functional organopolysiloxane can be produced by well-known conventional manufacturing methods, such as, for example, the methods disclosed in JP6298940.

In some embodiments, the monovalent aromatic hydrocarbon groups constitute not less than about 15 mol %, not less than about 20 mol %, or not less than about 25 mol % of all the organic groups in the epoxy-functional organopolysiloxane. This is due to the fact that when the content of the monovalent aromatic hydrocarbon groups is below the lower limit of the range, the cured product can become prone to cracking as a result of a decrease in toughness, in other embodiments, the monovalent aromatic hydrocarbon groups can constitute more less than 15 mol % of all the organic groups in the epoxy-functional organopolysiloxane.

In some embodiments, the epoxy-functional organopolysiloxane can have an average of at least two silicon-bonded epoxy-substituted organic groups per molecule. The siloxane units having epoxy-functional groups can constitute about 2 mol % to about 50 mol %, about 10 mol % to about 40 mol %, or, 15 mol % to 40 mol % of all the siloxane units, If there is less than 2 mol % of such siloxane units, the density of cross-linking during curing can be low, which can make it difficult to obtain sufficient hardness in the cured product, On the other hand, an amount exceeding 50 mol % can be unsuitable because it can bring about a decrease in the heat resistance of the cured product.

Ammo-Functional Curing Agent

The present invention includes a reaction product of an amino-functional curing agent and the epoxy-functional organopolysiloxane. The curing agent can have any suitable chemical structure, provided that the curing agent has an average of at least two nitrogen-bonded hydrogen atoms per molecule. The at least two nitrogen-bonded hydrogen atoms can be bonded to different nitrogen atoms.

In embodiments, the amino-functional curing agent functions as a crosslinking agent, rather than a chain extender. The curing agent can function by reacting with and thereby crosslinking epoxy groups of the epoxy-functional organopolysiloxane. Tertiary amines generally do not react with the epoxy groups in the desired fashion; rather, an N—H group is more effective. Primary amines and secondary amines are useful compounds, and can react with epoxide-functionalities to produce, for example, aminoalcohols. Thus, some embodiments of the amino-functional curing agent include at least one amine that is a primary amine, or includes at least two amines that are either primary or secondary amines.

Examples of suitable amino-functional curing agents useful for preparing the membranes of the present invention include those selected from the group including amines, aminosilanes, ketimines, aldimines, and mixtures thereof. Examples of suitable amino-functional curing agents include those disclosed in U.S. Patent Application Publication US 2006/0058451. The curing agent can react with the epoxy-functional organopolysiloxane ingredient to give a reaction product of the amino-functional curing agent and the epoxy-functional siloxane resin. The membrane of the present invention includes the reaction product of the amino-functional curing agent and the epoxy-functional siloxane resin.

Suitable amines that can be included in the amino-functional curing agent of this invention include amines and polyamines, aliphatic amine adducts, polyamidoamines, cycloaliphatic amines and polyamines, and cycloaliphatic amine adducts, and aromatic amines. Suitable polyamines include those described in U.S. Pat. No. 3,668,183. Amine curing agents can include primary amines, cycloaliphatic diamines, isophorone diamines, and other secondary amines such as those available, for example, from Air Products of Allentown, Pa., under the product name Ancamine and, more specifically, Ancamine 2457and Ancamine K54; from Huntsman of Houston Tex., under the product name XTJ-590 (a reactive polyether diamine); and primary amines such as those available from Huntsman under the product name Jeffamine® and, more specifically, the Jeffamine® D-series, including Jeffamine® D400(polyoxypropylenediamine) to Jeffamine® D2000. Other examples of suitable amines sold under the product name Jeffamine® include Jeffamine® ED-series, EDR-series, T-series, SD-series, ST-series.

Suitable amines can include Jeffamine® T-series, including Jeffamine(r) T-403. Jeffamine® T-403 is a polyetheramine characterized by repeating oxypropylene units in the backbone. As shown by the structure below, Jeffamine® T-403 is a trifunctional primary amine having an average molecular weight of approximately 440, with amine groups located on secondary carbon atoms at the ends of aliphatic polyether chains:

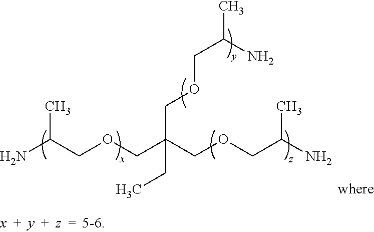

Suitable aminosilanes useful for forming fast-curing modified siloxane compositions of this invention include those having the general formula

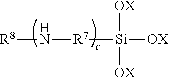

where “c” is an integer of from 1 to 6, each R⁷ is a difunctional organic radical that can include, for example, aryl, alkyl, dialkylaryl, alkoxyalkyl, and cycloalkyl radicals, and where R⁷ can vary within each repeated unit. Each X can be the same or different, and can be alkyl, hydroxyalkyl, alkoxyalkyl and hydroxy alkoxyalkyl groups containing less than about six carbon atoms. Each R⁸ is a monovalent organic radical that can include, for example, hydrogen, aryl, alkyl, dialkylaryl, alkoxyalkyl, and cycloalkyl radicals.

Examples of suitable aminosilanes include, but are not limited to: N-(2-aminoethyl)-3-aminopropyltriethoxysilane, N-phenyl-3-aminopropyltrimethoxysilane, (3-trimethoxysilylpropyl)diethylenetriamine, 3-(3-ammophenoxy) propyltrimethoxysiiane, N-(2-aminoethyl)aminomethylphenyltrimethoxysilane (with ortho, meta, or para substitution), N-(2-aminoethyl)-3-aminopropyl-tris-(2-ethylriexoxy)silane, N-(6-amino-n-hexyl)-(3-aminopropyl)-trimethoxysilane, 3-aminopropyl-tris-(methoxyethoxy)silane, 3-aminopropyltrimethoxysilane, 3-aminopropyltriethoxysilane, 3-aminopropyl-methyldimethoxysilane, N-(2-aminoethyl)-3-aminopropyltrimethoxysilane, and N-(2-aminoethyl)-3-aminopropyl-methyldimethoxysilane.

In some examples, suitable amines can be amine-functional organopolysiloxanes. These structures can be similar to those described herein for the epoxy-functional organopolysiloxanes above but an epoxy-functional group replaced by an amine-functional group, such that the amine-functional organopolysiloxanes have an average of at least two nitrogen-bonded hydrogen atoms per molecule. Suitable amine-functional groups include, but are not limited to, monovalent amine groups such as 3-aminopropyl, 2-aminoethyl, aminomethyl, 6-aminohexyl, 11-aminoundecyl, 3-(n-allylamino)propyl, n-(2-aminoethyl)-3-aminopropyl, N-(2-aminoethyl)-3-aminoisobutyl, p-aminophenyl, 2-ethylpyridine, and 3-propylpyrroie groups. In some embodiments, R² and R⁴ may be independently selected from tertiary amine groups, such as bis(2-hydroxyethyl)-3-aminopropyl, N,N-dimethyl-3-aminopropyl, N,N-diethyl-3-aminopropyl, and N,N-diethylaminomethyl. In some embodiments, the amine-functional groups may be independently selected from aminoalkyl groups having the formula R′-(NH-A′)_{q}-NH-A-, wherein A and A′ are each independently a linear or branched alkylene group having 1 to 6 carbon atoms and optionally containing an ether linkage; q=0-4; R′ is hydrogen or an alkyl or hydroxyalkyl group having 1 to 4 carbon atoms. Examples of such aminoalkyl groups include, but are not limited to, —(CH₂)₃NH₂, —(CH₂)₄NH₂, —(CH₂)₃NH(CH₂)₂NH₂, —CH₂CH(CH₃)CH₂NH(CH₂)₂NH₂, —(CH₂)₃NHCH₂CH₂NH(CH₂)₂NH₂, —CH₂CH(CH₃)CH₂NH(CH₂)₃NH₂, —CH₂CHMeCH₂NH(CH₂)₂NHCO(CH₂)₃OH, —(CH₂)₃NH(CH₂)₄NH₂, and —(CH₂)₃O(CH₂)₂NH₂.

In some embodiments, the amine-functional organopolysiloxane may be selected from poly[dimethyl, methyl (aminoethylaminoisobutyl)] siloxane, poly[dimethyl, methyl (aminoethylaminopropyl)] siloxane, poly [(dimethyl, methylaminopropyl)] siloxane, aminopropyl-terminated polydimethylsiloxane, aminoethylaminopropyl-terminated polydimethylsiloxane, aminoethylaminoisobutyl-terminated polydimethylsiloxane, and MQ, MDT, and MDTT(Phenyl) resins having an average of at least one amine-substituted group per molecule.

Examples of product names and the corresponding manufacturers of some aminosilanes useful as the amino-functional curing agent of the present invention include: Z6020, Z6011, XI-6100, and X16150 manufactured by Dow Corning; Silquest A1100, A1101, A1102, A1108, A1110, A1120, A1126, A1130, A1387, Y9632, A1637, A-2120 and A2639, and CoatOSil 2810 manufactured by GE; ED117 manufactured by W acker; Dynasylan AMMO, AMEO-P, AMEO-T, DAMO, TRIAMO, 1122, 1126, 1146, 1189, 1204, 1411and 1505 all manufactured by Degussa; and KBE-602, KBE-603 and KBE-903 manufactured by Shin-Etsu. Examples of aminosilanes can include are difunctional silanes that include aminoethylaminopropyltrimethoxysilane, aminopropyltrimethoxysilane and ammopropyltriethoxysiiane. Suitable aminosilanes can include A1110 and A1120, both made by GE.

Suitable ketimines or aldimines useful for the amino-functional curing agent of the present invention include those obtained by the reaction of an amine with either a ketone or an aldehyde, respectively, and include diketimines and dialdimines such as those described in U.S. Pat. No. 3,668,183. Examples of suitable ketimines include those available, for example, from Air Products under the product name 2457 (dimethylisobutyl ketone ketimine of diethylenetriamine); from Bayer of Leverkusen, Germany under the product name LS2965 (dimethylisobutyl ketone ketimine of isophorone diamine); and from Asabi Denka under the product names EH-235-RS-A and KBE-9103 (ketiminopropyltriethoxysiianes) from Shine-Etsu. An example of a suitable aldimine includes a dialdimine of isophorone diamine, available from, for example, Huls of Germany under the product name A139.

The selection of the amino-functional curing agent of the present invention will depend on the particular type and application of the membrane to be formed, and on the other ingredients that will, be used. For example, membranes of the present invention can be formed using a combination of more than one type of curing agent. For example, a primary and/or secondary amine can be used in conjunction with an aminosilane. Additionally, polyether amino-functional amines can be used to add flexibility to the resulting membrane, or to reduce the raw material cost of the materials.

In some embodiments, the use of ketimines or aldimines as the amino-functional curing agent can reduce raw material costs and/or increase the life of the container in which the reaction takes place. If desired, aminosilane can be hybridized with a ketimine or aldimine to reduce raw material costs or to increase the life of the container in which the reaction takes place.

Other Optional Ingredients

The membrane or the composition that forms the membrane can, in some embodiments, include additional components. Without limitation, examples of such optional additional components include surfactants, emulsifiers, dispersants, polymeric stabilizers, crosslinking agents, combinations of polymers, crosslinking agents, catalysts useful for providing a secondary polymerization or crosslinking of particles, rheology modifiers, density modifiers, aziridine stabilizers, cure modifiers such as hydroquinone and hindered amines, free radical initiators, polymers, diluents, acid acceptors, antioxidants, heat stabilizers, flame retardants, scavenging agents, silylating agents, foam stabilizers, solvents, diluents, hydrosilylation-reactive diluents, plasticizers, fillers and inorganic particles, pigments, dyes and dessicants. Liquids can optionally be used. An example of a liquid includes water, an organic solvent, any liquid organic compound, a silicone liquid, organic oils, ionic fluids, and supercritical fluids. Other optional ingredients include polyethers having at least one alkenyl or akynyl group per molecule, thickening agents, fillers and inorganic particles, stabilizing agents, waxes or wax-like materials, silicones, organofunctional siloxanes, alkylmethylsiloxanes, siloxane resins, silicone gums, silicone carbinol fluids, water soluble or water dispersible silicone polyether compositions, silicone rubber, hydrosilylation catalyst inhibitors, adhesion promoters, heat stabilizers, UV stabilizers, and flow control additives.

Membrane

The present invention can include the step of forming a membrane. The membrane can be formed on at least one surface of a substrate. For any membrane to be considered “on” a substrate, the membrane can be attached (e.g. adhered) to the substrate, or be otherwise in contact with the substrate without being adhered. The substrate can have any surface texture, and can be porous or non-porous. The substrate can include surfaces that are not coated with a membrane by the step of forming a membrane. All surfaces of the substrate can be coated by the step of forming a membrane, one surface can be coated, or any number can be coated.

The step of forming a membrane can include two steps. In the first step, the composition that forms the membrane can be applied to at least one surface of the substrate. In the second step, the applied composition that forms the membrane can be cured to form the membrane. In some embodiments, the curing process of the composition can begin before, during, or after application of the composition to the surface. The curing process transforms the composition that forms the membrane into the membrane. The composition that forms the membrane can be in a liquid state. The membrane can be in a solid state.

The composition that forms the membrane can be applied using conventional coating techniques, for example, immersion coating, spin coating, dipping, spraying, brushing, roll coating, extrusion, screen-printing, pad printing, or inkjet printing.

Curing the composition that forms the membrane can include the addition of a curing agent or initiator such as, for example, an amino-functional curing agent. In some embodiments, the curing process can begin immediately upon addition of the curing agent or initiator. The addition of the curing agent or initiator may not begin the curing process immediately, and can require additional curing steps. In other embodiments, the addition of the curing agent or initiator can begin the curing process immediately, and other curing steps can also be used. The addition of the curing agent or initiator can begin the curing process, but not bring it to a point where there composition is cured to the point of being fully cured, or of being unworkable. Thus, the curing agent or initiator can be added before or during the coating process, and further processing steps can complete the cure to form the membrane.

Curing the composition that forms the membrane can include a variety of methods, including exposing the polymer to ambient temperature, elevated temperature, moisture, or radiation. In some embodiments, curing the composition can include combination of methods.

The membrane of the present invention can have any suitable thickness. In some examples, the membrane has a thickness of from about 1 μm to about 20 μm. In some examples, the membrane has a thickness of from about 0.1 μm to about 200 μm. In other examples, the membrane has a thickness of from about 0.01 μm to about 2000 μm.

The membrane of the present invention can be selectively permeable to one substance over another. In one example, the membrane is selectively permeable to one gas over other gases or liquids. In another example, the membrane is selectively permeable to more than one gas over other gases or liquids. In one embodiment, the membrane is selectively permeable to one liquid over other liquids or gases. In another embodiment, the membrane is selectively permeable to more than one liquid over other liquids. In some examples, the membrane has an ideal CO₂/N₂ selectivity of at least about 40, at least about 30, at least about 20, or at least about 10. In some examples, the membrane has a CO₂/CH₄ selectivity of at least about 20, at least about 15, at least about 10, or at least about 3, In another example, the membrane has a CO₂/N₂ selectivity of at least about 25, 30. 40. 50. 60 or at least about 65. In some embodiments, with a CO₂/N₂ mixture for example, the membrane has a CO₂ permeation coefficient of at least 100 Barrers, 300 Barrers, 500 Barrers, 700 Barrers, 800 Barrers, 900 Barrers, 1000 Barrers, 1100 Barrers, 1200 Barrers, 1300 Barrers, 1400 Barrers, 1500 Barrers, 1700 Barrers, 1800 Barrers, 1900 Barrers, 2000 Barrers or at least about 2100 Barrers.

The membrane of the present invention can have any suitable shape. In some examples, the membrane of the present invention is a plate-and-frame membrane, a spiral wound membrane, a tubular membrane, a capillary fiber membrane or a hollow fiber membrane. In some embodiments, the membrane may be used in conjunction with a liquid that enhances gas transport, such as in a membrane contactor (e.g. a device that permits mass transfer between a gaseous phase and a liquid phase across a membrane without dispersing the phases in one another).

Supported Membrane

In some embodiments of the present invention, the membrane is supported on a porous or highly permeable non-porous substrate. A supported membrane has the majority of the surface area of at least one of the two major sides of the membrane contacting a porous or highly permeable non-porous substrate. A supported membrane on a porous substrate can be referred to as a composite membrane, where the membrane is a composite of the membrane and the porous substrate. The porous substrate on which the supported membrane is located can allow gases to pass through the pores and to reach the membrane. The supported membrane can be attached (e.g. adhered) to the porous substrate. The supported membrane can be in contact with the substrate without being adhered. The porous substrate can be partially integrated, fully integrated, or not integrated into the membrane.

A coating can be formed on the at least one porous surface of the substrate or on the at least one surface of the highly permeable non-porous substrate. Alternately, a porous or highly permeable non-porous substrate can be placed in contact with the formed coating before, during, or after curing of the coating. In some examples, a porous substrate can have its pores filled at the surface to provide a smooth surface for formation of a membrane; after formation of the membrane, the composition filling the pores can be dried or otherwise removed or shrunk to restore the porosity of the substrate. In some examples, the supported membrane is made in a manner identical to that disclosed herein pertaining to a free-standing membrane, but with the additional step of placing or adhering the free-standing membrane on a porous substrate to make a supported membrane.

The substrate can be any suitable shape, including planar, curved, or any combination thereof. Examples of porous substrates or highly permeable non-porous substrates include a sheet, tube or hollow fiber. The porous substrate or highly permeable non-porous substrate can be smooth, be corrugated or patterned, or have any amount of surface roughness.

The porous substrate can be any suitable porous material known to one of skill in the art, in any shape. For example, the substrate can be a filter. The porous substrate can be woven or non-woven. The porous substrate can be a frit, a porous sheet, or a porous hollow fiber. For example, the at least one surface can be flat, curved, or any combination thereof. The surface can have any perimeter shape. The porous substrate can have any number of surfaces, and can be any three-dimensional shape. Examples of three-dimensional shapes include cubes, spheres, cones, and planar sections thereof with any thickness, including variable thicknesses. The porous substrate can have any number of pores, and the pores can be of any size, depth, shape, and distribution. In one example, the porous substrate has a pore size of about 0.2 μm to about 500 μm. The at least one surface can have any number of pores. In some examples, the pore size distribution may be asymmetric across the thickness of the porous sheet, film or fiber.

Suitable examples of porous substrates include porous polymeric films, fibers or hollow fibers, or porous polymers or any suitable shape or form. Examples of polymers that can form porous polymers suitable for use as a porous substrate in embodiments of the present invention include those disclosed in U.S. Pat. No. 7,858,197. For example, suitable polymers include polyethylene, polypropylene, polysulfones, polyamides, polyether ether ketone (PEEK), polyarylates, polyaramides, polyethers, polyarylethers, polylmides, polyetherimides, polyphthalamides, polyesters, polyacrylates, polymethacrylates, cellulose acetate, polycarbonates, polyacrylonitrile, polytetralluoroethylene and other fluorinated polymers, polyvinylalcohol, polyvinylacetate, syndiotactic or amorphous polystyrene, Kevlar(tm) and other liquid crystalline polymers, epoxy resins, phenolic resins, polydimethylsiloxane elastomers, silicone resins, fluorosilicone elastomers, rluorosilicone resins, polyurethanes, and copolymers, blends or derivatives thereof. Suitable porous substrates can include, for example, porous glass, various forms and crystal forms of porous metals, ceramics and alloys, including porous alumina, zirconia, titania, and steel. Suitable porous substrates can include, for example, a support formed from the hydrosilylation-curable silicone composition of the present invention or formed using the method of surface treatment of the present invention, or a combination thereof.

Free-Standing Membrane

In some embodiments of the present invention, the membrane is unsupported, also referred to as free-standing. The majority of the surface area on each of the two major sides of a membrane that is free-standing is not contacting a substrate, whether the substrate is porous or not. In some embodiments, a membrane that is free-standing can be 100% unsupported. A membrane that is free-standing can be supported at the edges or at the minority (e.g. less than 50%) of the surface area on either or both major sides of the membrane. The support for a free-standing membrane can be a porous substrate or a nonporous substrate. Examples of suitable supports for a free-standing membrane can include any examples of supports given in the above section Supported Membrane. A free-standing membrane can have any suitable shape, regardless of the percent of the free-standing membrane that is supported. Examples of suitable shapes for free-standing membranes include, for example, squares, rectangles, circles, tubes, cubes, spheres, cones, and planar sections thereof, with any thickness, including variable thicknesses.

A support for a free-standing membrane can be attached to the membrane in any suitable manner, for example, by clamping, with use of adhesive, by melting the membrane to the edges of the substrate, or by chemically bonding the membrane to the substrate by any suitable means. The support for the free-standing membrane can be not attached to the membrane but in contact with the membrane and held in place by friction or gravity. The support can include, for example, a frame around the edges of the membrane, which can optionally include one or more cross-beam supports within the frame. The frame can be any suitable shape, including a square or circle, and the cross-beam supports, if any, can form any suitable shape within the frame. The frame can be any suitable thickness. The support can be, for example, a cross-hatch pattern of supports for the membrane, where the cross-hatch pattern has any suitable dimensions.

In some embodiments, a free-standing membrane is made by the steps of coating or applying a composition onto a substrate, curing the composition, and partially or fully removing the membrane from the substrate. After application of the composition to the substrate, the assembly can be referred to as a laminated film or fiber. During or after the curing process the membrane can be at least partially removed from at least one substrate. In some examples, after the unsupported membrane is removed from a substrate, and the unsupported membrane is attached to a support, as described above. In some examples, an unsupported membrane is made by the steps of coating a composition onto one or more substrates, curing the composition, and removing the membrane from at least one of the one or more substrates, while leaving at least one of the one or more substrates in contact with the membrane. In some embodiments, the membrane is entirely removed from the substrate. In one example, the membrane can be peeled away from the substrate. In one example, the substrate can be removed from the membrane by melting, subliming, chemical etching, or dissolving in a solvent. In one example, the substrate is a water soluble polymer that is dissolved by purging with water. In one example, the substrate is a fiber or hollow fiber, as described in U.S. Pat. No. 6,797,212 B2.

In examples that include a substrate, the substrate can be porous or nonporous. The substrate can be any suitable material, and can be any suitable shape, including planar, curved, solid, hollow, or any combination thereof. Suitable materials for porous or nonporous substrates include any materials described above as suitable for use as porous substrates in supported membranes, as well as any suitable less-porous materials. In some examples, the membrane can be heated, cooled, washed, etched, subjected to air pressure, or otherwise treated to facilitate removal from the substrate.

Method of Separation of Gases

The present invention also provides a method of separating gas or vapor components in a feed gas mixture by use of the membrane described herein. The method includes contacting a first side of a membrane with a feed gas mixture to produce a permeate gas mixture on a second side of the membrane and a retentate gas mixture on the first side of the membrane. The permeate gas mixture is enriched in the first gas component. The retentate gas mixture is depleted in the first gas component. The membrane can include any suitable membrane as described herein. The permeate and retentate gas mixture can be enriched and depleted, respectively, in any suitable number of gas components.

The membrane can be tree-standing or supported by a porous or permeable substrate. In some embodiments, the pressure on either side of the membrane can be about the same. In other embodiments, there can be a pressure differential between one side of the membrane and the other side of the membrane. For example, the pressure on the retentate side of the membrane can be higher than the pressure on the permeate side of the membrane. In other examples, the pressure on the permeate side of the membrane can be higher than the pressure on the retentate side of the membrane.

The feed gas mixture can include any mixture of gases or vapors. For example, the feed gas mixture can include hydrogen, carbon dioxide, nitrogen, ammonia, methane, water vapor, hydrogen sulfide, or any combination thereof. The feed gas can include any gas or vapor known to one of skill in the art. The membrane can be selectively permeable to any one gas or vapor in the feed gas, or to any of several gases in the feed gas. The membrane can be selectively permeable to all but any one gas in the feed gas.

Any number of membranes can be used to accomplish the separation. For example, one membrane can be used. The membranes can be manufactured as flat sheets or as fibers and can be packaged into any suitable variety of modules including hollow fibers, sheets or arrays of hollow fibers or sheets. Common module forms include hollow fiber modules, spiral wound modules, plate-and-frame modules, tubular modules and capillary fiber modules. Modules can be operated as single membrane modules or organized further into arrays or banks of modules. The individual membrane modules or arrays or banks of modules can further be configured into additional staged superstructures, such as in series, parallel or cascade configurations, to allow enhanced flux or separation.

The permeate side of the one or more membranes can be operated under a positive pressure, ambient pressure, or negative pressure (e.g. vacuum) with or without a sweep gas or a sweep liquid such as found in a membrane contactor (e.g. a device that permits mass transfer between a gaseous phase and a liquid phase across a membrane without dispersing the phases in one another). The sweep gas can be any gas, and can originate from outside the process or be recycled from within the process, or include a mixture thereof. For example, hollow fiber modules can be fed from the bore side or from the shell side, at any position of entry. The feed gas inlets and permeate gas outlets can be positioned to permit a counter-current, cross-current or co-current flow configuration.

In embodiments, the membrane can be used to separate one or more liquids from one or more liquids. In some embodiments, the membrane can be used to separate one or more gases from one or more liquids. In another embodiment, the membrane can be used to separate one or more liquids from one or more gases. In another example, the membrane can be used to separate one or more gases from one or more gases that contain a suspended solid or liquid. In another example, the membrane can be used to separate a liquid from a liquid that contains a suspended or dissolved solid or gas. In yet another example, the membrane can be used to separate a solute that is dissolved in one or more gases or liquids from one or more gases or liquids.

### Examples

The invention is not limited to the examples given herein.

### Reference Example 1

### Membrane Preparation

Prior to preparing membranes, the compositions described in the Examples and Comparative Examples were placed in a vacuum chamber under a pressure of less than 50 mm Hg for 5 minutes at ambient laboratory temperature (21± about 2° C.) to remove any entrained air. Membranes were then prepared by drawing the composition described in the Examples into a uniform thin film with a doctor blade on a fluorosilicone-coated polyethylene terephthalate release liner. The samples were then immediately placed into a forced air convection oven at a time and temperature sufficient to cure the films. For each composition, the curing schedule was determined by using differential scanning calorimetry to observe the temperatures at which the curing exotherms were observed. After curing, the membranes were then recovered by carefully peeling the cured compositions from the release film and transferred onto a fritted glass support for testing of permeation properties as described in Reference Example 2. The thickness of the samples was measured with a profilometer (Tencor P11Surface Profiler).

### Reference Example 2

### Permeation Measurements

Gas permeability coefficients and ideal selectivities in a binary gas mixture were measured by a permeation cell including an upstream (feed) and downstream (permeate) chambers that are separated by the membrane. Each chamber had one gas inlet and one gas outlet. The upstream chamber was maintained at 35 psi pressure and was constantly supplied with a 50/50 (volume) mixture of CO₂ and N₂ at a flow rate of 200 seem. The membrane was supported on a glass fiber filter disk with a diameter of 83mm and a maximum pore diameter range of 10-20 μm (Ace Glass). The membrane area was defined by a placing a butyl rubber gasket with a diameter of 50 mm (Exotic Automatic & Supply) on top of the membrane. The downstream chamber was maintained at 5 psi pressure and was constantly supplied with a pure He stream at a flow rate of 20 sccm. To analyze the permeability and separation factor of the membrane, the outlet of the downstream chamber was connected to a 6-port injector equipped with a 1-mL injection loop. On command, the 6-port injector injected a 1-mL sample into a gas chromatograph (GC) equipped with a thermal conductivity detector (TCD). The amount of gas permeated through the membrane was calculated by calibrating the response of the TCD detector to the gases of interest. The reported values of gas permeability and selectivity were obtained from measurements taken after the system has reached a steady state in which the permeate side gas composition becomes invariant with time. All experiments were run at ambient laboratory temperature (21± about 2° C.).

### Example 1

A 90 mm diameter porous polypropylene support with a pore size of 0.2microns and average thickness of 150 microns was taped down on a fluorosilicone-coated mylar release liner and placed on a clipboard so that no air bubbles could infiltrate under the support.

A reaction mixture was prepared by combining 1.89 grams of epoxypropoxypropyl terminated poly(dimethylsiloxane) (DMS-E12, Gelest) and 0.28 grams of Jeffamine® T-403 (Huntsman) in a 10 gram dental mixer cup. The components were mixed for 30 seconds in a Flack-Tek Speed mixer DAC 150 dental mixer.

The reaction mixture was then poured on top of polypropylene support and drawn across using a curved lab spatula. The mixture was allowed to set for 1 minute in order to soak into and through the filter. Any excess mixture was then wiped oil of filter using a Kimwipe.

The sample was then placed in a 125° C. oven and cured for 3 hours. The cured membrane composite was peeled off of the fluorosilicone-coated Mylar release liner, and gas permeation properties were tested in a permeation cell as described in Reference Example 2 using a 50/50 (volume) mixture of CO₂ and N2. The cured membrane showed a CO₂ permeation coefficient of 940 Barters and a CO₂/N₂ ideal separation factor of 41.

### Example 2

A 90 mm diameter polypropylene support was taped down on a fluorosilicone-coated Mylar release liner and placed on a clipboard so that no air bubbles could infiltrate under the support.

A reaction mixture was prepared by combining 1.89 grams of DMS-E12 and 0.25 grams of Jeffamine® T-403 in a 10 gram dental mixer cup (Part A) and mixed for 30 seconds in a Flack-Tek Speed mixer DAC 150 dental mixer. Part A was then combined with 5.64 wt % of Cabosil TS-610 (treated fumed silica) and mixed for two consecutive 30 second cycles in a Flack-Tek Speed mixer DAC 150 dental mixer. The mixture was then placed on fluorosilicone-coated Mylar release liner and a film was drawn down by hand using a doctor blade designed for a 4 mil nominal wet film thickness (BYK). The sample was then placed in a 150° C. oven and cured for 2 hours. The cured membrane was then peeled off of the release liner and its gas permeation properties were tested using a 50/50 (volume) mixture of CO₂ and N₂ in the permeation cell as described in Reference Example 2. The CO₂ permeation coefficient of the membrane was 1570 Barrers with a CO₂/N₂ ideal separation factor of 17.7.

### Example 3

A silicone elastomer was prepared by mixing 2.50 g of DMS-E12 and 4.53 g of aminopropylmethylsiloxane-dimethylsiloxane copolymer (AMS-152, Geiest) in an aluminum dish. The mixture was then placed in a 150° C. oven for 255 minutes. The mixture was allowed to cool to room temperature followed by drawing down into a film on a WTF-40ER release liner (Burkhardi/Freeman, coated polyester) using a doctor blade designed for a 6 mil nominal wet film thickness (BYK). The sample was placed in a 150° C. oven and cured for 14 hours. The cured silicone elastomer membrane was separated from the release liner using a razor blade and its gas permeation properties were tested according to Reference Example 2. The cured silicone membrane showed a CO₂ permeation coefficient of 3610 Barrers and a CO₂/N₂ ideal separation factor of 10.7.

### Example 4

A silicone elastomer was prepared by mixing 1.504 g of DMS-E12 and 4.518 g of AMS-152 in an aluminum dish. The mixture was then placed in a 150° C. oven for 255 minutes. The mixture was allowed to cool to room temperature followed by drawing down into a film on a WTF-4QER release liner (Burkhardt/Freeman, coated polyester) using a doctor blade designed for a 6 mil nominal wet film thickness (BYK). The sample was placed in a 150° C. oven and cured for 14 hours. The cured silicone elastomer membrane was separated from the release liner using a razor blade and its gas permeation properties were tested according to Reference Example 2. The cured silicone membrane showed a CO₂permeation coefficient of 3290 Barrers and a CO₂/N₂ ideal separation factor of 9.4.

### Example 5

A silicone elastomer was prepared by mixing 5.67 g of DMS-E12 and 0.84 g of Jeffamine® T-403 in an aluminum dish. The mixture was then placed in a 150° C. oven for 70 minutes. The mixture was allowed to cool to room temperature followed by drawing down into a film on a Teflon-fluorinated ethylene propylene (Teflon-FEP, DuPont) release liner using a doctor blade designed for a 6 mil nominal wet film thickness (BYK). The sample was placed in a 150° C. oven and cured for 2 hours. The cured silicone elastomer was separated from the release liner using a razor blade and the gas permeation properties of the film were tested according to Reference Example 2. The cured silicone composite showed a CO₂ permeation coefficient of 2260 Barrers and a CO₂/N₂ ideal separation factor of 15.2.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed can be resorted to by those skilled in the art, and that such modifications and variations are considered to be within the scope of this invention as defined by the appended claims.

1. A membrane, comprising:
a reaction product of an epoxy-functional organopolysiloxane and an amino-functional curing agent;
wherein the organopolysiloxane has an average of at least two silicon-bonded epoxy-substituted organic groups per molecule and the curing agent has an average of at least two nitrogen-bonded hydrogen atoms per molecule.

2. The membrane of claim 1, wherein the epoxy-functional organopolysiloxane
can be represented by the average siloxane unit formula:
(R¹R²R³SiO_{1/2})ₐ(R⁴R⁵SiO_{2/2})_{b}(R⁶SiO_{3/2})_{c}(SiO_{4/2})_{d} (I)
wherein R¹, R², R³, R⁴, R⁵, and R⁶ are organic groups independently selected from any optionally further substituted C₁₋₅ organic group, 0≦a<0.95, 0≦b<1, 0≦c<1, 0≦d<0.95, a+b+c+d=1, and the epoxy-functional organopolysiloxane has a number-average molecular weight of at least about 300.

3. The membrane of claim 2, wherein R¹, R², R³, R⁴, R⁵, and R⁶ are organic groups independently selected from C₁₋₁₅ monovalent aliphatic hydrocarbon groups, C₄₋₁₅monovalent aromatic hydrocarbon groups, and monovalent epoxy-substituted organic groups.

4. The membrane of claim 1, wherein the amino-functional curing agent is a polyoxyalkyleneamine.

5. The membrane of claim 1, wherein the membrane is free-standing.

6. The membrane of claim 1, wherein the reaction product is formed by subjecting the epoxy-functional organopolysiloxane and the amino-functional curing agent to at least one of hydrosilylation-curing, condensation-curing, radiation-curing, and peroxide-curing.

7. The membrane of claim 1, wherein the membrane has a carbon dioxide to nitrogen (CO₂/N₂) selectivity of at least about 10.

8. The membrane of claim 1, wherein the membrane has a carbon dioxide (CO₂) permeability coefficient of at least about 900 Barrers.

9. The membrane of claim 1, wherein the membrane has a thickness of about 0.1 μm to about 200 μm.

10. The membrane of claim 1, wherein the membrane is selected from a plate-and-frame membrane, a spiral wound membrane, a tubular membrane, a capillary fiber membrane,, and a hollow fiber membrane.

11. A method of separating gas components in a feed gas mixture, comprising: contacting a first side of a membrane with a feed gas mixture comprising a first gas
component and a second gas component to produce a permeate gas mixture on a second side of the membrane and a retentate gas mixture on the first side of the membrane;
wherein the permeate gas mixture is enriched in the first gas component and the retentate gas mixture is depleted in the first gas component;
wherein the membrane comprises a reaction product of an epoxy-functional organopolysiloxane having an average of at least two silicon-bonded epoxy-substituted organic groups per molecule and an amino-functional curing agent having an average of at least two nitrogen-bonded hydrogen atoms per molecule.

12. A method of forming a membrane, comprising:
forming a coating, the coating comprising an epoxy-functional organopolysiloxane and an amino-functional curing agent; and,
curing the coating, to provide a membrane comprising a reaction product of the epoxy-functional organopolysiloxane and the amino-functional curing agent;
wherein the organopolysiloxane has an average of at least two silicon-bonded epoxy-substituted organic groups per molecule and the curing agent has an average of at least two nitrogen-bonded hydrogen atoms per molecule.

13. The method of claim 11, wherein the first gas is carbon dioxide and the feed gas mixture comprises nitrogen.

14. The membrane of claim 1, wherein the epoxy-functional group is chosen from 2,3-epoxypropyl, 3,4-epoxybutyl, 4,5-epoxypentyl, 2,3-epoxypropoxy, epoxypropoxypropyl, 2-glycidoxyethyl, 3-glycidoxypropyl, 4-glycidoxybutyl, 2-(glycidoxycarbonyl)propyl, 3-(3,4-epoxycylohexyl) propyl, 2-(3,4-epoxycyclohexyl)ethyl, 2-(2,3-epoxycylopentyl)ethyl, 2-(4-methyl-3,4-epoxycyclohexyl)propyl, 2-(3,4-epoxy-3-methylcylohexyl)-2-methylethyl, and 5,6-epoxyhexyl.

15. The membrane of claim 1, wherein the epoxy-functional organopolysiloxane is an epoxypropoxypropyl-terminated poly(dimethylsiloxane).

16. The membrane of claim 1, wherein the amino-functional curing agent has an average of at least two nitrogen-bonded hydrogen atoms per molecule.

17. The membrane of claim 1, wherein the epoxy-functional organopolysiloxane has a number-average molecular weight of at least about 300.

18. The membrane of claim 1, wherein the membrane is a free-standing hollow fiber.

19. The membrane of claim 1, further comprising a porous substrate, wherein the membrane is on the porous substrate.

20. The membrane of claim 19, wherein the porous substrate comprises at least one chosen from a fiber, a filter, a frit, and polypropylene.
